(19) United States
(12) Patent Application Publication
(10) Pub. No.: US 2009/0276782 A1
(43) Pub. Date: Nov. 5, 2009

(54) RESOURCE MANAGEMENT METHODS AND SYSTEMS

(76) Inventors: Chih-Hua WANG, Taoyuan County (TW); I-Fen SHIH, Taoyuan County (TW); Jian-Chyn LIU, Taoyuan County (TW); Kuo-Hsi TAI, Taoyuan County (TW)

Correspondence Address: BIRCH STEWART KOLASCH & BIRCH, PO BOX 747, FALLS CHURCH, VA, 22040-0747, US

(21) Appl. No.: 12/434,236

(22) Filed: May 1, 2009

(30) Foreign Application Priority Data
May 2, 2008 (TW) 97116549

(51) Int. Cl. G06F 9/46

(52) U.S. Cl. 718/103; 718/104

(57) ABSTRACT

Resource management methods and systems are provided. First, it is determined whether a resource is currently being used. When the resource is currently being used by a first program, a release notification is transmitted to the first program to release the resource.

### CROSS REFERENCE TO RELATED APPLICATIONS

This Application claims priority of Taiwan Patent Application No. TW97116549, filed on 2 May 2008, the entirety of which is incorporated by reference herein.

### BACKGROUND OF THE INVENTION

1. Field of the Invention

The disclosure relates generally to resource management methods and systems, and, more particularly to methods and systems that manage resources commonly used by programs in an electronic device, and related operating systems.

2. Description of the Related Art

Recently, electronic devices, such as portable devices, have become more and more technically advanced and multifunctional. For example, a portable device may have a phone function, e-mail message capabilities, an advanced address book management system, a media playback system, and various other functions. Due to increased convenience and functions of the devices, these devices have become necessities of life.

Generally, when a program is executed, hardware and/or software resources of the electronic device will be used by the program. For example, when a phone application is executed, the hardware resources corresponding to audio encoding/decoding are requested to be used. Similarly, when a multimedia application is executed, the hardware resources corresponding to image and/or audio encoding/decoding are requested to be used. Since the electronic device has limited resources, when different programs requesting the same resources are simultaneously executed, the electronic device must design an appropriate scheduling mechanism to manage the timing of the respective programs to use the same resources.

Conventionally, in some electronic devices, such as portable devices requesting critical resource management operations, when a specific program requests to use a resource, the specific program must ask the other programs one by one, to check and see which programs are currently using the same resource. When no program is currently using the resource, the specific program may then use the resource. Since respective programs design their own checking mechanism to determine the use situations of resources by all other programs in the electronic device, an additional cost for program development is incurred. Additionally, when new programs are added to the electronic device, the checking mechanisms for all programs must be adjusted to recognize the new programs, increasing the difficulty of program maintenance.

### BRIEF SUMMARY OF THE INVENTION

Resource management methods and systems, and related operating systems are provided.

In an embodiment of a resource management method, it is determined whether a resource is currently being used. When the resource is currently being used by a first program, a release notification is transmitted to the first program to release the resource.

An embodiment of a resource management system comprises a resource, a first program, and an execution management module. The execution management module determines whether the resource is currently being used. When the resource is currently being used by the first program, the execution management module transmits a release notification to the first program to release the resource.

An embodiment of an operating system comprises at least a management program. The management program determines whether a resource is currently being used. When the resource is currently being used by a first program, the management program transmits a release notification to the first program to release the resource.

Resource management methods and systems, and related operating systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a resource management system of the invention; and

FIG. 2 is a flowchart of an embodiment of a resource management method of the invention.

### DETAILED DESCRIPTION OF THE INVENTION

Resource management methods and systems, and related operating systems are provided.

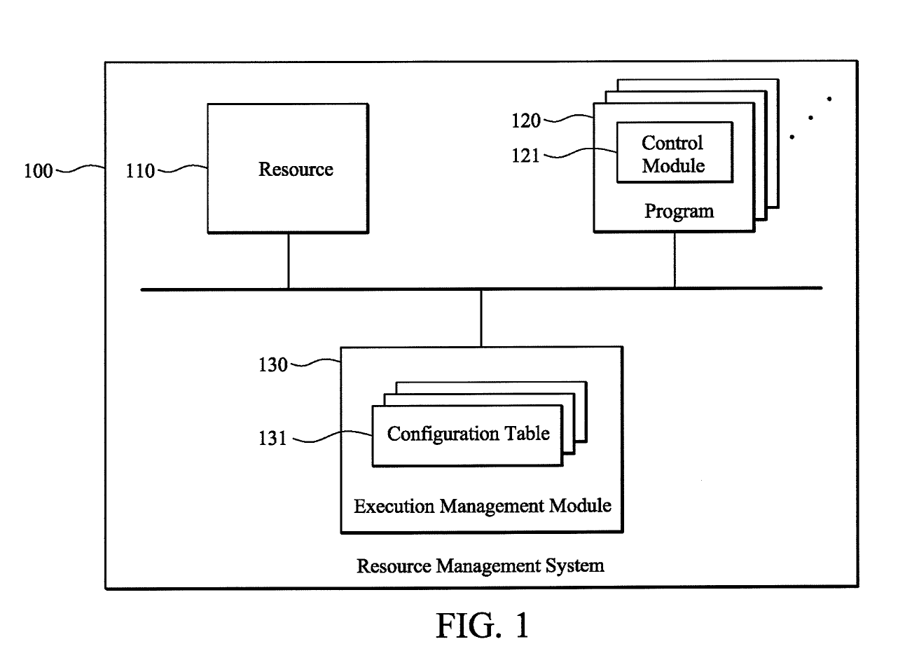

FIG. 1 is a schematic diagram illustrating an embodiment of a resource management system of the invention. The resource management system can be used in an electronic device, such as a portable device comprising handheld devices such as a media player, a PDA (Personal Digital Assistant), a GPS (Global Positioning System) device, a touch-sensitive phone, a smart phone, and a mobile phone.

The resource management system 100 comprises at least one resource 110 of the electronic device, a plurality of programs 120, and an execution management module 130. The resource 110 may be a hardware resource, such as a processor, an audio encoder/decoder, an image encoder/decoder, display unit, or others of the electronic device. Additionally, the resource 110 may be also a software resource, such as a library for function calls, a simulator simulating a hardware component, or others of the electronic device. The programs 120 can be executed on the electronic device. The programs 120 may comprise phone applications and multimedia applications, such as a phone function, a video phone function, a camera function, a data streaming application, and a music/video playback application, and others. When the programs 120 are executed, the resource 110 of the electronic device is requested to be used. It is noted that, each program 120 may comprise a control module 121 to communicate with the execution management module 130, and determine related operations of the program 120. The execution management module 130 has configuration tables 131 corresponding to the respective programs 120. Each configuration table 131 records whether the resource 110 will be used when the corresponding program 120 is executed, and a priority, a time setting (time duration) and a use determination setting corresponding to the corresponding program 120. The execution management module 130 performs the resource management method of the invention according to the configuration tables 131 corresponding to respective programs 120. Related detail is discussed later.

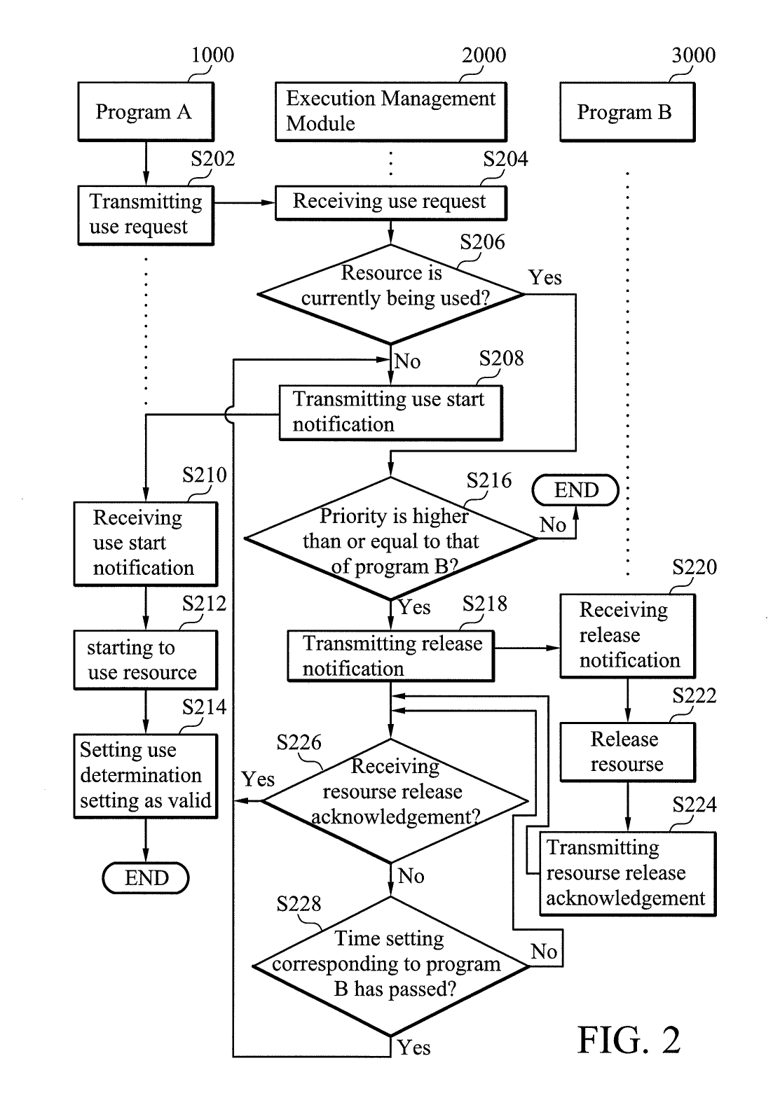

FIG. 2 is a flowchart of an embodiment of a resource management method of the invention. The resource management method can be used in an electronic device, such as a portable device comprising handheld devices such as a media player, a PDA (Personal Digital Assistant), a GPS (Global Positioning System) device, a touch-sensitive phone, a smart phone, and a mobile phone, wherein the electronic device has at least one resource.

When a program A (1000) in the electronic device wants to execute and use a hardware resource, in step S202, the control module of the program A (1000) transmits a use request to the execution management module 2000. In step S204, the execution management module 2000 receives the use request from the program A (1000). In step S206, the execution management module 2000 determines whether the requested hardware resource is currently being used. It is understood that, as described, the execution management module has configuration tables corresponding to respective programs in the electronic device. Each configuration table records whether the resource will be used when the corresponding program is executed. The execution management module 2000 can check the configuration table corresponding to the program A (1000) to determine the resource requested by the program A (1000), and determine other programs that might use the same resource according to the other configuration tables. Additionally, each configuration table records a use determination setting corresponding to the program. In some embodiments, the use determination setting may be a flag. When a program uses the resource, the corresponding use determination setting is set as valid. Otherwise, when program does not use the resource, the corresponding use determination setting is set as invalid. In some embodiments, the use determination setting may be an execution window. When a program uses the resource, the corresponding execution window is established. Otherwise, when a program does not use the resource, the corresponding execution window does not exist. The execution management module 2000 can determine whether the use determination setting of a respective program is valid or not, to determine whether the respective program is currently using the resource. If the resource requested by the program A (1000) is not currently being used (No in step S206), in step S208, the execution management module 2000 transmits a use start notification to the program A (1000). In step S210, the program A (1000) receives the use start notification from the execution management module 2000, and in response to the use start notification, in step S212, starts to use the resource. When the program A (1000) uses the resource, in step S214, the control module of the program A (1000) sets the use determination setting corresponding to the program A (1000) as valid.

If the resource requested by the program A (1000) is currently being used by a program B (3000) (Yes in step S206), in step S216, the execution management module 2000 determines whether the priority of the program A (1000) is higher than or equal to the priority of the program B (3000) according to the priorities respectively recorded in the use determination settings of the programs A (1000) and B (2000). If the priority of the program A (1000) is not higher than or equal to the priority of the program B (3000) (No in step S216), the procedure is completed. It is understood that, in some embodiments, when the program B (3000) is completed actively, the execution management module 2000 can transmit a use start notification to the program A (1000). If the priority of the program A (1000) is higher than or equal to the priority of the program B (3000) (Yes in step S216), in step S218, the execution management module 2000 transmits a release notification to the program B (3000). In step S220, the program B (3000) receives the release notification from the execution management module 2000, and in response to the release notification, in step S222, releases the currently used resource. In some embodiments, the program B (3000) automatically terminates its execution. After the program B (3000) releases the resource, in step S224, the control module of the program B (3000) transmits a resource release acknowledgement to the execution management module 2000. It is noted that, after the execution management module 2000 the release notification is transmitted to the program B (3000), in step S226, the execution management module 2000 determines whether the resource release acknowledgement is received from the program B (3000). If the resource release acknowledgement is received (Yes in step S226), in step S208, the execution management module 2000 transmits a use start notification to the program A (1000). In step S210, the program A (1000) receives the use start notification from the execution management module 2000, and in response to the use start notification, in step S212, starts to use the resource. Similarly, when the program A (1000) uses the resource, in step S214, the control module of the program A (1000) sets the use determination setting corresponding to the program A (1000) as valid. If no resource release acknowledgement is received (No in step S226), in step S228, the execution management module 2000 determines whether the time setting corresponding to the program B (3000) has passed according to the time setting recorded in the configuration table corresponding to the program B (3000). If the time setting corresponding to the program B (3000) has not been passed (No in step S228), the procedure returns to step S226. If the time setting corresponding to the program B (3000) has passed (Yes in step S228), in step S208, the execution management module 2000 transmits a use start notification to the program A (1000). In step S210, the program A (1000) receives the use start notification from the execution management module 2000, and in response to the use start notification, in step S212, starts to use the resource. Similarly, when the program A (1000) uses the resource, in step S214, the control module of the program A (1000) sets the use determination setting corresponding to the program A (1000) as valid.

Following is an example. The electronic device comprises a phone application and a multimedia application, wherein the phone application and the multimedia application commonly use an audio encoder/decoder hardware resource. The priority of the phone application is higher than the priority of the multimedia application. Say for example, the multimedia application is using the audio encoder/decoder of the electronic device. When the phone application wants to use the audio encoder/decoder, the phone application transmits a use request to the execution management module. After the execution management module recognizes the audio encoder/decoder requested by the phone application as currently being used by the multimedia application, and the priority of the phone application is higher than the priority of the multimedia application, the execution management module transmits a release notification to the multimedia application. After the multimedia application receives the release notification, the multimedia application can automatically and actively release the audio encoder/decoder, and transmit a resource release acknowledgement to the execution management module. After the execution management module receives the resource release acknowledgement, the execution management module transmits a use start notification to the phone application. After the phone application receives the use start notification, the phone application starts to use the audio encoder/decoder.

Therefore, the resource management methods and systems can appropriately manage resources commonly used by programs in the electronic device. It is understood that, in some embodiments, the resource management method of the application can be implemented as an operating system and executed in the electronic device. The operating system can comprise the management program performing the resource management operations.

Resource management methods and systems, and related operating systems, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A resource management method, comprising:
determining whether a resource is currently being used; and
when the resource is currently being used by a first program, transmitting a release notification to the first program to release the resource.

2. The method of claim 1, wherein the resource is actively released by the first program.

3. The method of claim 2, further comprising terminating the execution of the first program by the first program.

4. The method of claim 1, wherein the step of determining whether the resource is currently being used further comprises a step of receiving a use request from a second program, wherein the use request indicates that the second program is requesting to use the resource.

5. The method of claim 4, further comprising:
transmitting a use start notification to the second program; and
in response to the use start notification, the second program starts to use the resource.

6. The method of claim 4, wherein the first program and the second program respectively have a configuration table recording a corresponding priority, and the method further comprises the steps of:
determining whether the priority of the second program is higher than or equal to the priority of the first program; and
if the priority of the second program is higher than or equal to the priority of the first program, transmitting the release notification to the first program.

7. The method of claim 5, wherein the first program has a configuration table recording a time setting corresponding to the first program, and the method further comprises a step of transmitting the use start notification to the second program when the time setting corresponding to the first program has passed.

8. The method of claim 5, further comprising:
receiving a resource release acknowledgement from the first program, wherein the resource release acknowledgement is transmitted from the first program after the first program releases the resource; and
transmitting the use start notification to the second program after the resource release acknowledgement is received.

9. The method of claim 1, wherein the first program has a configuration table recording whether the resource is being used or not when the first program is executed, and the method determines the resource is being used by the first program according to the configuration table.

10. The method of claim 1, wherein the first program has a configuration table recording a use determination setting corresponding to the first program, and the use determination setting is set as valid when the first program uses the resource, and the method determines whether the first program is currently using the resource by determining whether the use determination setting corresponding to the first program is valid or not.

11. A resource management system, comprising:
a resource;
a first program; and
an execution management module determining whether the resource is currently being used, and transmitting a release notification to the first program to release the resource when the resource is currently being used by a first program.

12. The system of claim 11, wherein the first program comprises a control module, and the resource is actively released by the control module of the first program.

13. The system of claim 12, wherein the control module of the first program terminates the execution of the first program.

14. The system of claim 11, further comprising a second program to transmit a use request, wherein the use request indicates that the second program is requesting to use the resource.

15. The system of claim 14, wherein the execution management module further transmits a use start notification to the second program, and in response to the use start notification, the second program starts to use the resource.

16. The system of claim 14, wherein the first program and the second program respectively have a configuration table recording a corresponding priority, and the execution management module further determines whether the priority of the second program is higher than or equal to the priority of the first program, and if the priority of the second program is higher than or equal to the priority of the first program, the release notification is transmitted to the first program.

17. The system of claim 15, wherein the execution management module further receives a resource release acknowledgement from the first program, wherein the resource release acknowledgement is transmitted from the first program after the first program releases the resource, and the execution management module transmits the use start notification to the second program after the resource release acknowledgement is received.

18. The system of claim 11, wherein the resource comprises a hardware resource or a software resource of the electronic device.

19. The system of claim 11, wherein the electronic device comprises a portable device, and the first program comprises a phone application or a multimedia application.
